(19) United States
(12) Patent Application Publication
(10) Pub. No.: US 2009/0011970 A1
(43) Pub. Date: Jan. 8, 2009

(54) LAUNDRY MULTI-COMPARTMENT POUCH COMPOSITION

(76) Inventor: Marc Francois Theophile Evers, Strombeek-Bever (BE)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/166,771

(22) Filed: Jul. 2, 2008

(30) Foreign Application Priority Data
Jul. 2, 2007 (EP) 07 111 540.6

(51) Int. Cl. C11D 17/04

(52) U.S. Cl. 510/277

(57) ABSTRACT

This invention relates to a laundry pouch made from a water-soluble film and having at least two compartments, containing a solid component and a liquid component, wherein the solid phase contains a peroxide source and the liquid phase contains bleach activator. The present invention also relates to a method for treating laundry by placing the pouch, according to the present invention, in the drum of the washing machine.

### FIELD OF THE INVENTION

This invention relates to a laundry pouch made from a water-soluble film and having at least two compartments, containing a solid component and a liquid component, wherein the solid phase contains a peroxide source and the liquid phase contains bleach activator.

### BACKGROUND TO THE INVENTION

Laundry detergent products nowadays come in a number of various product forms, such as granules, liquids and tablets. Each form having its advantages and disadvantages, which gives the consumer a large choice of detergent products they can use. Unitised doses of detergents are found to be more and more attractive and convenient to consumers. Indeed, this “unit dose” are easy to handle and avoid the need of the consumer to measure the product, thereby giving rise to a more precise dosing and avoiding wasteful overdosing or under-dosing. For this reason laundry detergent products in tablet or in pouch forms have become very popular. However, there is still a need for a unitised dose form which allows optimum delivery of active components and which provides improved effective bleaching performances.

Indeed, the satisfactory removal of bleachable soils/stains such as tea, fruit juice and coloured vegetable soils from stained fabrics is a particular challenge to the formulator of a composition for use in a laundry washing method, especially for “unit-dose” forms. Traditionally, the removal of such bleachable stains has been facilitated by the use of bleach components such as oxygen bleaches, including hydrogen peroxide and organic peroxyacids.

The growth in usage of organic peroxyacid bleach precursors has mirrored a decrease in fabric wash temperatures which itself has accompanied an increase in the proportion of fabrics that are coloured. One problem that has become more significant as a result of these trends is that of “patchy” localised discolouration to fabric colours and materials caused by the development of localised high concentrations of bleaching species.

High transient concentrations can arise for several reasons: the bleaching species may itself have an intrinsically low solubility, its solubility may have been hindered by the presence of other materials such as viscous surfactant phases or the agitation regime in the immediate environment of the bleach species may not be high enough to disperse the dissolved bleach. Where a peroxyacid bleach precursor forms a component of the composition the potential problem is increased. In addition to the potential for localised high concentrations of perhydroxyl ion arising from dissolution of the inorganic perhydrate contained in laundry detergent compositions, the perhydrolysis of the peroxyacid bleach precursor can give rise to significant localised peroxyacid bleach concentrations. This is especially true when the detergent composition contains high levels (for example, greater than about 3% by weight) of the peroxyacid bleach precursor compound and/or when sodium percarbonate is used as the source of hydrogen peroxide. The development of so-called concentrated products and their delivery via dispensing devices placed in the machine drum together with the fabric load has merely served to exacerbate these problems.

Accordingly, there is still a need to provide detergent compositions in which the organic peroxyacid bleach precursor is incorporated in a form that minimises and preferably eliminates patchy discolouration of fabric colours during its dissolution, whilst still providing acceptable bleachable soil/stain removal from soiled/stained fabrics and which is, in the same time, more attractive and convenient to the consumers.

The Applicants have now found a new laundry composition which avoid the problem of “patchy” discolouration and which is found to be more attractive and convenient to the consumers.

The inventors have now found that a laundry multi-compartment pouch can solves this problem. Thus, the present invention encompass a laundry multi-compartment pouch made from a water-soluble film and having at least two compartments.

In another aspect, the present invention encompass a method of treating laundry by placing the pouch of the present invention into in the drum of the washing machine. Indeed, it has surprisingly be found that the pouch of the present invention provide excellent bleaching performance without producing “patchy” damage and discolouration. Another advantage of the present invention is that the composition is more attractive and convenient to use by the consumers.

Thus another object of the present invention is the use of the multi-compartment pouch, herein disclosed, in view of reducing the patchy damage when treating fabrics.

One of the other benefits according to the present invention is that the pouch allow incompatible ingredients to be incorporated separated from one another, for example in different compartments. Helping thus to reduce the area of contact of these incompatible materials and thus reduce the occurrence of any reaction between such materials.

Pouches for detergents as such are known in the art to be useful to provide unit dose compositions and to separate ingredients from one another. For example, U.S. Pat. No. 5,224,601 describes a package made with different compartments for different materials. However, this type of structure and also other pouches known in the art have their problems and does no contain high amount of percarbonate.

EP 1283862 or EP 1262539 relate to a multi-compartment pouch made from a water-soluble film and having at least two compartments. EP 1276842 or EP 1314653 relates to a composition, in form of a pouch, for it use in automatic dishwashing.

However, none of these documents disclose laundry compositions having bleach activators in the liquid component, and a high level of peroxide source in the solid component.

### SUMMARY OF THE INVENTION

The present invention relates to a laundry multi-compartment pouch made from a water-soluble film and having at least two compartments. The pouch of the present invention comprises a composition containing a solid component and a liquid component, wherein:

(a) a first compartment comprises a liquid component, said liquid compartment containing a bleach activator;

(b) a second compartment comprises a solid component, said solid compartment containing from about 60 to about 95 % of peroxide source.

The present invention also relates to a method for treating laundry by placing the pouch, according to the present invention, in the drum of the washing machine.

The present invention also encompasses the use of the pouch herein defined in view of reducing the patchy damage when treating fabrics.

### DETAILED DESCRIPTION OF THE INVENTION

The Pouch

The multi-compartment pouch, according to the present invention, comprises a composition containing a solid component and a liquid component, wherein the first compartment comprises a liquid component and wherein the second compartment comprises a solid component. An essential feature of the present invention is that the solid component contains from about 60 to about 95% of peroxide source and that the liquid compartment contains a bleach activator.

The multi-compartment pouch of the invention, herein referred to as “pouch”, comprises at least two compartments. The pouch herein is typically a closed structure, made of materials described herein, enclosing a volume space which is separated into at least two, preferably two compartments.

In a preferred embodiment, the pouch of the invention is a dual-compartment pouch. An essential feature of the present invention, is that the pouch comprises a composition comprising a solid component and a liquid component.

The pouch can be of any form, shape and material which is suitable to hold the composition, e.g. without allowing the release of the composition from the pouch prior to contact of the pouch to water. The exact execution will depend on for example the type and amount of the composition in the pouch, the number of compartments in the pouch, the characteristics required from the pouch to hold, protect and deliver or release the compositions.

The pouch may be of such a size that it conveniently contains either a unit dose amount of the composition herein, suitable for the required operation, for example one wash, or only a partial dose, to allow the consumer greater flexibility to vary the amount used, for example depending on the size and/or degree of soiling of the wash load.

Another characteristic of the present invention is that the pouch is made from a water-soluble film which encloses an inner volume, said inner volume is divided into the compartments of the pouch.

The compartments of the pouch herein defined are closed structures, made from a water-soluble film which enclose a volume space which comprises the solid component or the liquid component of the composition. Said volume space is preferably enclosed by a water-soluble film in such a manner that the volume space is separated from the outside environment. The solid or liquid component that are comprised by the compartment of the pouch are contained in the volume space of the compartment, and are separated from the outside environment by a barrier of water-soluble film.

The term “separated” means for the purpose of this invention “physically distinct, in that a first ingredient comprised by a compartment is prevented from contacting a second ingredient if said second ingredient is not comprised by the same compartment which comprises said first ingredient”.

The term “outside environment” means for the purpose of this invention “anything which cannot pass through the water-soluble film which encloses the compartment and which is not comprised by the compartment”.

The compartment is suitable to hold the solid or liquid component, e.g. without allowing the release of the components from the compartment prior to contact of the pouch to water. The compartment can have any form or shape, depending on the nature of the material of the compartment, the nature of the components or composition, the intended use, amount of the components etc.

It may be preferred that the compartment which comprises the liquid component also comprises an air bubble, preferably the air bubble has a volume of no more than about 50%, preferably no more than about 40%, more preferably no more than about 30%, more preferably no more than about 20%, more preferably no more than about 10% of the volume space of said compartment. Without being bound by theory, it is believed that the presence of the air bubble increases the tolerance of the pouch to the movement of liquid component within the compartment, thus reducing the risk of the liquid component leaking from the compartment.

The pouch is made from a water-soluble film, said water-soluble film typically has a solubility of at least about 50%, preferably at least about 75% or even at least about 95%, as measured by the method set out hereinafter using a glass-filter with a maximum pore size of 50 microns.

Gravimetric method for determining water-solubility of the material of the pouch:

10 grams±0.1 gram of material is added in a 400 ml beaker, whereof the weight has been determined, and 245 ml±1 ml of distilled water is added. This is stirred vigorously on magnetic stirrer set at 600 rpm, for 30 minutes. Then, the mixture is filtered through a folded qualitative sintered-glass filter with the pore sizes as defined above (max. 50 micron). The water is dried off from the collected filtrate by any conventional method, and the weight of the remaining polymer is determined (which is the dissolved or dispersed fraction). Then, the % solubility or dispersability can be calculated.

Preferred films are polymeric materials, preferably polymers which are formed into a film or sheet. The film can for example be obtained by casting, blow-moulding, extrusion or blow extrusion of the polymer material, as known in the art. Preferred polymers, copolymers or derivatives thereof are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferably the polymer is selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, most preferably polyvinyl alcohols, polyvinyl alcohol copolymers and hydroxypropyl methyl cellulose (HPMC). Preferably, the level of polymer in the film, for example a PVA polymer, is at least about 60%.

The polymer can have any weight average molecular weight, preferably from about 1000 to about 1,000,000, or even from about 10,000 to about 300,000 or even from about 15,000 to about 200,000 or even from about 20,000 to about 150,000.

Mixtures of polymers can also be used. This may in particular be beneficial to control the mechanical and/or dissolution properties of the compartments or pouch, depending on the application thereof and the required needs. For example, it may be preferred that a mixture of polymers is present in the film, whereby one polymer material has a higher water-solubility than another polymer material, and/or one polymer material has a higher mechanical strength than another polymer material. It may be preferred that a mixture of polymers is used, having different weight average molecular weights, for example a mixture of PVA or a copolymer thereof of a weight average molecular weight of about 10,000-40,000, preferably around about 20,000, and of PVA or copolymer thereof, with a weight average molecular weight of about 100,000 to about 300,000, preferably around about 150,000.

Also useful are polymer blend compositions, for example comprising hydrolytically degradable and water-soluble polymer blend such as polylactide and polyvinyl alcohol, achieved by the mixing of polylactide and polyvinyl alcohol, typically comprising about 1-35% by weight polylactide and approximately from about 65% to about 99% by weight polyvinyl alcohol, if the material is to be water-soluble.

It may be preferred that the polymer present in the film is from about 60% to about 98% hydrolysed, preferably about 80% to about 90%, to improve the dissolution of the material. Most preferred are films which comprise a PVA polymer with similar properties to the film which comprises a PVA polymer and is known under the trade reference M8630, as sold by Chris-Craft Industrial Products of Gary, Ind., US.

The film herein may comprise other additive ingredients than the polymer or polymer material. For example, it may be beneficial to add plasticisers, for example glycerol, ethylene glycol, diethyleneglycol, propylene glycol, sorbitol and mixtures thereof, additional water, disintegrating aids. It may be useful when the pouched composition is a detergent composition, that the pouch or compartment material itself comprises a detergent additive to be delivered to the wash water, for example organic polymeric soil release agents, dispersants, dye transfer inhibitors.

The compartments and preferably pouch as a whole are made from water-soluble film. Suitable examples of commercially available water-soluble films include polyvinyl alcohol and partially hydrolysed polyvinyl acetate, alginates, cellulose ethers such as carboxymethylcellulose and methylcellulose, polyethylene oxide, polyacrylates and combinations of these.

Preferably, the water-soluble film of the pouch of the present invention comprises a polyvinyl alcohol polymer.

The pouch can be prepared according to methods known in the art. The pouch is typically prepared by first cutting an appropriately sized piece of pouch material, preferably the pouch material. The pouch material is then folded to form the necessary number and size of compartments and the edges are sealed using any suitable technology, for example heat sealing, wet sealing or pressure sealing. Preferably, a sealing source is brought into contact with the pouch material, heat or pressure is applied and the pouch material is sealed.

The pouch material is typically introduced to a mould and a vacuum applied so that the pouch material is flush with the inner surface of the mould, thus forming a vacuum formed indent or niche in said pouch material. This is referred to as vacuum-forming. Another suitable method is thermo-forming. Thermo-forming typically involves the step of forming an open pouch in a mould under application of heat, which allows the pouch material to take on the shape of the mould.

Typically more than one piece of pouch material is used for making multi-compartment pouches. For example, a first piece of pouch material can be vacuum pulled into the mould so that said pouch material is flush with the inner walls of the mould. A second piece of pouch material can then be positioned such that it at least partially overlaps, and preferably completely overlaps, with the first piece of pouch material. The first piece of pouch material and second piece of pouch material are sealed together. The first piece of pouch material and second piece of pouch material can be made of the same type of material or can be different types of material.

In a preferred process, a piece of pouch material is folded at least twice, or at least three pieces of pouch material are used, or at least two pieces of pouch material are used wherein at least one piece of pouch material is folded at least once. The third piece of pouch material, or a folded piece of pouch material, creates a barrier layer that, when the sachet is sealed, divides the internal volume of said sachet into at least two or more compartments.

The pouch can also be prepared by fitting a first piece of the pouch material into a mould, for example the first piece of film may be vacuum pulled into the mould so that said film is flush with the inner walls of the mould. A composition, or component thereof, is typically poured into the mould. A pre-sealed compartment made of pouch material, is then typically placed over the mould containing the composition, or component thereof. The pre-sealed compartment preferably contains a composition, or component thereof. The pre-sealed compartment and said first piece of pouch material may be sealed together to form the pouch.

Composition

The pouch comprises a composition, typically said composition is contained in the volume space of the pouch. Preferred compositions are laundry cleaning compositions or laundry fabric care compositions, preferably laundry compositions. Typically, the composition comprises such an amount of a cleaning composition, that one or a multitude of the pouched compositions is or are sufficient for one wash.

An essential feature of the present invention is that the composition comprises a solid component and a liquid component. A first compartment comprises the solid component and a second compartment comprises the liquid component. It is important that the solid component and liquid component are separated by a water-soluble film.

Liquid Component

The liquid component is comprised in a compartment of the pouch. Said compartment is a different compartment to the compartment that comprises the solid component.

As an essential feature, the liquid component of the present invention contains a bleach activator. The composition herein comprises a bleach activator or mixtures thereof, preferably an organic peroxyacid bleach precursor.

The amount of bleach activator present in the liquid component can be up to about 100% of the weight of the liquid composition. Preferably, the bleach activator will be present in an amount comprise between about 10 and about 90%, more preferably between about 20 and about 80% of the amount of the liquid composition.

By “bleach activator”, it is meant herein a compound which reacts with peroxygen bleach like hydrogen peroxide to form a peracid. The peracid thus formed constitutes the activated bleach. Suitable bleach activators to be used herein include those belonging to the class of esters, amides, imides, or anhydrides. Examples of suitable compounds of this type are disclosed in British Patent GB 1 586 769 and GB 2 143 231 and a method for their formation into a prilled form is described in European Published Patent Application EP-A-62 523. Suitable examples of such compounds to be used herein are tetracetyl ethylene diamine (TAED), sodium 3,5,5 trimethyl hexanoyloxybenzene sulphonate, diperoxy dodecanoic acid as described for instance in U.S. Pat. No. 4,818,425 and nonylamide of peroxyadipic acid as described for instance in U.S. Pat. No. 4,259,201 and n-nonanoyloxybenzenesulphonate (NOBS).

Also suitable are N-acyl caprolactams selected from the group consisting of substituted or unsubstituted benzoyl caprolactam, octanoyl caprolactam, nonanoyl caprolactam, hexanoyl caprolactam, decanoyl caprolactam, undecenoyl caprolactam, formyl caprolactam, acetyl caprolactam, propanoyl caprolactam, butanoyl caprolactam pentanoyl caprolactam or mixtures thereof. A particular family of bleach activators of interest was disclosed in EP 624 154, and particularly preferred in that family is acetyl triethyl citrate (ATC). Acetyl triethyl citrate has the advantage that it is environmental-friendly as it eventually degrades into citric acid and alcohol. Furthermore, acetyl triethyl citrate has a good hydrolytical stability in the product upon storage and it is an efficient bleach activator. Finally, it provides good building capacity to the laundry additive.

In a preferred embodiment the bleach activator present in the liquid composition is selected from nonanoyloxybenzenesulphonate (NOBS), n-nonanoylsuccinimid (NOSI), N-acyl caprolactams, tetracetyl ethylene diamine (TAED), acetyl triethyl citrate (ATC) or short chain tri-glycerides, such as triacetin.

In a more preferred embodiment, the bleach activator is triacetin.

It may be preferred that the composition comprises at least two peroxy acid bleach precursors, preferably at least one hydrophobic peroxyacid bleach precursor and at least one hydrophilic peroxy acid bleach precursor, as defined herein. The production of the organic peroxyacid occurs then by an in situ reaction of the precursor with a source of hydrogen peroxide.

The bleach activator may alternatively, or in addition comprise a preformed peroxy acid bleach. Preferably, at least one of the bleach activators, preferably a peroxy acid bleach precursor having an average particle size, by weight, of from 600 microns to 1400 microns, preferably from 700 microns to 1100 microns is present in the composition herein.

Hereby, it may be preferred that at least about 80%, preferably at least about 90% or even at least about 95% or even substantially about 100% of the component or components comprising the bleach activator have a particle size of from about 300 microns to about 1700 microns, preferably from 425 microns to about 1400 microns.

Preferably, the liquid component of the invention comprises surfactant. Typically the surfactant is a liquid at room temperature. Preferably, the surfactant is a nonionic surfactant, an anionic surfactant or a combination thereof, most preferably the surfactant is a nonionic surfactant.

Preferably, said liquid component of the invention comprises a solvent or a perfume. Preferably, said liquid component comprises (by weight of the liquid component) at least about 2%, more preferably at least about 5%, more preferably at least about 10%, more preferably at least about 40% perfume.

Preferably, said liquid component comprises (by weight of liquid component) from about 0.1% to about 30%, more preferably from about 5% to about 25%, more preferably from about 10% to about 20% solvent. Preferably said solvent is an alcohol based solvent, more preferably said solvent is ethanol and, or n-butoxy propoxy propanol.

Preferably, the liquid component is substantially liquid in that at least about 90%, more preferably at least about 95%, more preferably at least about 98% ingredients comprised by the liquid component are in a liquid form at room temperature.

Solid Component

The solid component is comprised in a second compartment of the pouch. Said compartment is a different compartment to the compartment that comprises the liquid component.

An essential feature of the present invention is that the solid component of the pouch comprises a peroxide source in a amount of from about 60 to about 95% by weight of the composition.

Preferably the peroxide source will be present in an amount of from about 60 to about 95%, preferably from about 65 to about 85%, more preferably from about 70 to about 80% by weight of the solid component of the composition.

As used herein the expression “peroxide source” refers to any compound that produces perhydroxyl ions on contact with water. Suitable water-soluble sources of hydrogen peroxide for use herein include percarbonates, perborates and persilicates and mixtures thereof. Preferred ingredient is a perhydrate bleach, such as salts of percarbonates, particularly the sodium salts, and or organic peroxyacid bleach precursor.

Inorganic perhydrate salts are a preferred source of peroxide. Preferably these salts are present at a level of from about 60% to about 95% by weight, more preferably of from about 65% to about 85% by weight of the composition.

Examples of inorganic perhydrate salts include percarbonate, perphosphate, persulfate and persilicate salts. The inorganic perhydrate salts are normally the alkali metal salts. The inorganic perhydrate salt may be included as the crystalline solid without additional protection. For certain perhydrate salts however, the preferred executions of such granular compositions utilise a coated form of the material which provides better storage stability for the perhydrate salt in the granular product. Suitable coatings comprise inorganic salts such as alkali metal silicate, carbonate or borate salts or mixtures thereof, or organic materials such as waxes, oils, or fatty soaps.

Alkali metal percarbonates, particularly sodium percarbonate are preferred perhydrates herein. Sodium percarbonate is an addition compound having a formula corresponding to 2Na₂CO₃-3H₂O₂, and is available commercially as a crystalline solid. Potassium peroxymonopersulfate is another inorganic perhydrate salt of use in the compositions herein.

In a more preferred embodiment, the source of peracid will be sodium percarbonate.

The solid component of the composition will be an alkaline composition.

Said solid component preferably comprises (by weight of the solid component) at least about 10%, more preferably at least about 20%, more preferably at least about 30% water-insoluble solid material.

Preferably, said water-insoluble solid material includes water-insoluble building agents, preferably the water-insoluble building agent is an aluminosilicate, or water-insoluble fabric softening agent such as clay. Preferably, said water-insoluble solid material comprises a water-insoluble building agent. Preferred water-insoluble building agents are described in more detail hereinafter.

Said solid composition may comprises at least one detergent ingredient selected from the group consisting of building agent, chelating agent, enzyme, brightener, suds suppressor and dye. It may even be possible that part or all of the ingredients of the solid component are not pre-granulated, such as agglomerated, spray-dried, extruded, prior to incorporation into the compartment, and that the component is a mixture of dry-mixed powder ingredients or even raw materials. Preferred may be that for example less than about 60% or even less than about 40% or even less than about 20% of the component is a free-flowable pre-granulated granules.

Preferably the solid component is substantially solid in that at least about 90%, preferably at least about 95%, more preferably at least about 98% of the ingredients comprised by the solid component are in a solid form. Preferably the solid component comprises ingredients that are either difficult or costly to include in a substantially liquid composition or that are typically transported and supplied as solid ingredients which require additional processing steps to enable them to be included in a substantially liquid composition.

The composition may also comprise other conventional ingredients commonly used in laundry composition, such as surfactants, building agents, chelating agents, dye, polymers, brighteners, enzymes, suds boosters, suds suppressors, perfumes and mixtures thereof Preferably, the composition comprises at least one surfactant and at least one building agent. Unless otherwise specified, the components described herein can be incorporated either in the liquid component or in the solid component.

Detersive Surfactants

In a preferred embodiment, the composition will contain detersive surfactants. These surfactants can be found either of the solid or in the liquid component. Preferably, surfactants herein are in liquid form and are comprised by the liquid component of the composition.

The surfactants are selected from the group consisting of nonionic surfactants, anionic surfactants, cationic surfactants, zwitterionic surfactants and/or amphoteric surfactants.

Preferably, the surfactants, according to the present invention surfactant, are nonionic surfactants, anionic surfactants or combination thereof. In a preferred embodiment the composition will comprise nonionic surfactant.

Even more preferably, the nonionic surfactants herein are in liquid form and are comprised by the liquid component of the composition.

Suitable anionic surfactants include water-soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like). Typically, alkyl chains of C₁₂₋₁₆ are preferred for lower wash temperatures (e.g., below about 50° C.) and C₁₆₋₁₈ alkyl chains are preferred for higher wash temperatures (e.g., above about 50° C.).

Other suitable anionic surfactants for use herein are water-soluble salts or acids of the formula RO(A)ₘSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulfate, C₁₂-C₁₈E(1.0)M), C₁₂-C₁₈ alkyl polyethoxylate (2.25) sulfate, C₁₂-C₁₈E(2.25)M), C₁₂-C₁₈ alkyl polyethoxylate (3.0) sulfate C₁₂-C₁₈E(3.0), and C₁₂-C₁₈ alkyl polyethoxylate (4.0) sulfate C₁₂-C₁₈E(4.0)M), wherein M is conveniently selected from sodium and potassium.

Other particularly suitable anionic surfactants for use herein are alkyl sulphonates including water-soluble salts or acids of the formula RSO₃M wherein R is a C₆-C₂₂ linear or branched, saturated or unsaturated alkyl group, preferably a C₁₂-C₁₈ alkyl group and more preferably a C₁₄-C₁₆ alkyl group, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

Suitable alkyl aryl sulphonates for use herein include water-soluble salts or acids of the formula RSO₃M wherein R is an aryl, preferably a benzyl, substituted by a C₆-C₂₂ linear or branched saturated or unsaturated alkyl group, preferably a C₁₂-C₁₈ alkyl group and more preferably a C₁₄-C₁₆ alkyl group, and M is H or a cation, e.g., an alkali metal cation (e.g., sodium, potassium, lithium, calcium, magnesium etc) or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like).

The alkylsulfonates and alkyl aryl sulphonates for use herein include primary and secondary alkylsulfonates and primary and secondary alkyl aryl sulphonates. By “secondary C₆-C₂₂ alkyl or C₆-C₂₂ alkyl aryl sulphonates”, it is meant herein that in the formula as defined above, the SO₃M or aryl-SO₃M group is linked to a carbon atom of the alkyl chain being placed between two other carbons of the said alkyl chain (secondary carbon atom).

For example C₁₄-C₁₆ alkyl sulphonate salt is commercially available under the name Hostapur® SAS from Hoechst and C₈-alkylsulphonate sodium salt is commercially available under the name Witconate NAS 8® from Witco SA. An example of commercially available alkyl aryl sulphonate is Lauryl aryl sulphonate from Su.Ma. Particularly preferred alkyl aryl sulphonates are alkyl benzene sulphonates commercially available under trade name Nansa® available from Albright & Wilson.

Other anionic surfactants useful for detersive purposes can also be used herein. These can include salts (including, for example, sodium, potassium, ammonium, and substituted ammonium salts such as mono-, di- and triethanolamine salts) of soap, C₈-C₂₄ olefinsulfonates, sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl ester sulfonates such as C₁₄₋₁₆ methyl ester sulfonates; acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinate (especially saturated and unsaturated C₁₂-C₁8 monoesters) diesters of sulfosuccinate (especially saturated and unsaturated C₆-C₁₄ diesters), sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO⁻M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975, to Laughlin, et al. at Column 23, line 58 through Coluwnn 29, line 23 (herein incorporated by reference).

Other particularly suitable anionic surfactants for use herein are alkyl carboxylates and alkyl alkoxycarboxylates having from 4 to 24 carbon atoms in the alkyl chain, preferably from 8 to 18 and more preferably from 8 to 16, wherein the alkoxy is propoxy and/or ethoxy and preferably is ethoxy at an alkoxylation degree of from 0.5 to 20, preferably from 5 to 15. Preferred alkylalkoxycarboxylate for use herein is sodium laureth 11 carboxylate (i.e., RO(C₂H₄O)₁₀—CH₂COONa, with R═C₁₂-C₁₄) commercially available under the name Akyposoft® 100NV from Kao Chemical Gbmh.

Suitable amphoteric surfactants for use herein include amine oxides having the following formula R¹R²R³NO wherein each of R¹, R² and R³ is independently a saturated substituted or unsubstituted, linear or branched hydrocarbon chain of from 1 to 30 carbon atoms. Preferred amine oxide surfactants to be used according to the present invention are amine oxides having the following formula R¹R²R³NO wherein R¹ is an hydrocarbon chain comprising from 1 to 30 carbon atoms, preferably from 6 to 20, more preferably from 8 to 16, most preferably from 8 to 12, and wherein R² and R³ are independently substituted or unsubstituted, linear or branched hydrocarbon chains comprising from 1 to 4 carbon atoms, preferably from 1 to 3 carbon atoms, and more preferably are methyl groups. R¹ may be a saturated, substituted or unsubstituted linear or branched hydrocarbon chain. Suitable amine oxides for use herein are for instance natural blend C₈-C₁₀ amine oxides as well as C₁₂-C₁₆ amine oxides commercially available from Hoechst.

Suitable zwitterionic surfactants for use herein contain both a cationic hydrophilic group, i.e., a quaternary ammonium group, and anionic hydrophilic group on the same molecule at a relatively wide range of pHs. The typical anionic hydrophilic groups are carboxylates and sulfonates, although other groups like sulfates, phosphonates, and the like can be used. A generic formula for the zwitterionic surfactants to be used herein is:

R¹—N⁺(R²)(R³)R⁴X⁻

wherein R¹ is a hydrophobic group; R² is hydrogen, C₁-C₆ alkyl, hydroxy alkyl or other substituted C₁-C₆ alkyl group; R³ is C₁-C₆ alkyl, hydroxy alkyl or other substituted C₁-C₆ alkyl group which can also be joined to R² to form ring structures with the N, or a C₁-C₆ carboxylic acid group or a C₁-C₆ sulfonate group; R⁴ is a moiety joining the cationic nitrogen atom to the hydrophilic group and is typically an alkylene, hydroxy alkylene, or polyalkoxy group containing from 1 to 10 carbon atoms; and X is the hydrophilic group which is a carboxylate or sulfonate group.

Preferred hydrophobic groups R¹ are aliphatic or aromatic, saturated or unsaturated, substituted or unsubstituted hydrocarbon chains that can contain linking groups such as amido groups, ester groups. More preferred R¹ is an alkyl group containing from 1 to 24 carbon atoms, preferably from 8 to 18, and more preferably from 10 to 16. These simple alkyl groups are preferred for cost and stability reasons. However, the hydrophobic group R¹ can also be an amido radical of the formula Ra—C(O)—NH—(C(Rb)₂)ₘ, wherein Ra is an aliphatic or aromatic, saturated or unsaturated, substituted or unsubstituted hydrocarbon chain, preferably an alkyl group containing from 8 up to 20 carbon atoms, preferably up to 18, more preferably up to 16, Rb is selected from the group consisting of hydrogen and hydroxy groups, and m is from 1 to 4, preferably from 2 to 3, more preferably 3, with no more than one hydroxy group in any (C(R_{b})₂) moiety.

Preferred R² is hydrogen, or a C₁-C₃ alkyl and more preferably methyl. Preferred R3 is a C₁-C₄ carboxylic acid group or C₁-C₄ sulfonate group, or a C₁-C₃ alkyl and more preferably methyl. Preferred R⁴ is (CH₂), wherein n is an integer from 1 to 10, preferably from 1 to 6, more preferably is from 1 to 3.

Some common examples of betaine/sulphobetaine are described in U.S. Pat. Nos. 2,082,275, 2,702,279 and 2,255,082, incorporated herein by reference.

Examples of particularly suitable alkyldimethyl betaines include coconut-dimethyl betaine, lauryl dimethyl betaine, decyl dimethyl betaine, 2-(N-decyl-N,N-dimethyl-ammonia)acetate, 2-(N-coco N,N-dimethylammonio)acetate, myristyl dimethyl betaine, palmityl dimethyl betaine, cetyl dimethyl betaine, stearyl dimethyl betaine. For example Coconut dimethyl betaine is commercially available from Seppic under the trade name of Amonyl 265®. Lauryl betaine is commercially available from Albright & Wilson under the trade name Empigen BB/L®.

Examples of amidobetaines include cocoamidoethylbetaine, cocoamidopropyl betaine or C₁₀-C₁₄ fatty acylamidopropylene(hydropropylene)sulfobetaine.

For example C₁₀-C₁₄ fatty acylamidopropylene(hydropropylene)sulfobetaine is commercially available from Sherex Company under the trade name “Varion CAS® sulfobetaine”. A further example of betaine is Lauryl-imino-dipropionate commercially available from Rhone-Poulenc under the trade name Mirataine H₂C—HA®.

Suitable cationic surfactants for use herein include derivatives of quaternary ammonium, phosphonium, imidazolium and sulfonium compounds. Preferred cationic surfactants for use herein are quaternary ammonium compounds wherein one or two of the hydrocarbon groups linked to nitrogen are a saturated, linear or branched alkyl group of 6 to 30 carbon atoms, preferably of 10 to 25 carbon atoms, and more preferably of 12 to 20 carbon atoms, and wherein the other hydrocarbon groups (i.e. three when one hydrocarbon group is a long chain hydrocarbon group as mentioned hereinbefore or two when two hydrocarbon groups are long chain hydrocarbon groups as mentioned hereinbefore) linked to the nitrogen are independently substituted or unsubstituted, linear or branched, alkyl chain of from 1 to 4 carbon atoms, preferably of from 1 to 3 carbon atoms, and more preferably are methyl groups. Preferred quaternary ammonium compounds suitable for use herein are non-chloride/non halogen quaternary ammonium compounds. The counterion used in said quaternary ammonium compounds are compatible with any peracid and are selected from the group of methyl sulfate, or methylsulfonate, and the like. Preferred are trimethyl quaternary ammonium compounds like myristyl trimethylsulfate, cetyl trimethylsulfate and/or tallow trimethylsulfate. Such trimethyl quaternary ammonium compounds are commercially available from Hoechst, or from Albright & Wilson under the trade name EMPIGEN CM®.

Amongst the nonionic surfactants, alkoxylated nonionic surfactants and especially ethoxylated nonionic surfactants are suitable for use herein.

Suitable capped alkoxylated nonionic surfactants for use herein are according to the formula:

R¹(O—CH₂—CH₂)ₙ—(OR²)ₘ—O—R³

wherein R¹ is a C⁸-C²⁴ linear or branched alkyl or alkenyl group, aryl group, alkaryl group, preferably R1 is a C⁸-C¹⁸ alkyl or alkenyl group, more preferably a C₁₀-C₁₅ alkyl or alkenyl group, even more preferably a C¹⁰-C¹⁵ alkyl group; wherein R² is a C¹-C¹⁰ linear or branched alkyl group, preferably a C²-C¹⁰ linear or branched alkyl group; wherein R³ is a C¹-C¹⁰ alkyl or alkenyl group, preferably a C¹-C⁵ alkyl group, more preferably methyl; and wherein n and m are integers independently ranging in the range of from 1 to about 20, preferably from 1 to about 10, more preferably from 1 to about 5; or mixtures thereof.

These surfactants are commercially available from BASF under the trade name Plurafac® from HOECHST under the trade name Genapol® or from ICI under the trade name Symperonice® Preferred capped nonionic alkoxylated surfactants of the above formula are those commercially available under the tradename Genapol® L 2.5 NR from Hoechst, and Plurafac® from BASF. Particularly preferred surfactants are those selected from the group consisting of alkyl sulphate, alkyl sulphonate, alkyl ethoxy sulphate, alkyl benzene sulphonate, alkyl carboxylate, alkyl ethoxy carboxylate, amine oxides and mixtures thereof. More preferably the surfactant system comprises an alkyl sulphonate and an amine oxide.

Typically, the laundry additives according to the present invention preferably comprise the surfactant system at a level of from about 0.01% to about 30%, preferably from about 0.1% to about 15% and more preferably less than about 10% and most preferably from about 0.2% to about 5% by weight of the laundry additive.

### Chelating Agents

The composition herein, preferably comprises a chelating agent. The chelating agent can be either in the solid or in the liquid compartment. Preferably the chelating agent will be in the liquid phase.

Chelating agents are generally present at a level of from about 1%, preferably from about 2.5% from about 3.5% or even about 5.0% or even about 7% and preferably up to about 20% or even about 15% or even about 10% by weight of the composition herein.

By chelating agent it is meant herein components which act to sequester (chelate) heavy metal ions. These components may also have calcium and magnesium chelation capacity, but preferentially they show selectivity to binding heavy metal ions such as iron, manganese and copper.

The composition herein can comprise a chelating agent, for example, having two or more phosphonic acid or phosphonate groups, or two or more carboxylic acid or carboxylate groups, or mixtures thereof.

The laundry additive may comprise a chelating agent as a preferred optional ingredient. Suitable chelating agents may be any of those known to those skilled in the art such as the ones selected from the group comprising phosphonate chelating agents, amino carboxylate chelating agents, other carboxylate chelating agents, polyfunctionally-substituted aromatic chelating agents, ethylenediamine N,N′-disuccinic acids, or mixtures thereof.

Suitable phosphonate chelating agents for use herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®. Polyfunctionally-substituted aromatic chelating agents may also be useful in the laundry additives herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

Particularly preferred chelating agents to be used herein are amino aminotri(methylene phosphonic acid), di-ethylene-triamino-pentaacetic acid, diethylene triamine penta methylene phosphonate, b 1-hydroxy ethane diphosphonate, ethylenediamine N,N′-disuccinic acid, and mixtures thereof.

Building Agent

The compositions in accordance with the present invention preferably contain a water-soluble builder compound, typically present in detergent compositions at levels of from about 1% to about 60% by weight, preferably from about 3% to about 40% by weight, most preferably from about 5% to about 25% by weight of the composition.

Suitable water-soluble builder compounds include the water soluble monomeric carboxylates, or their acid forms, or homo or copolymeric polycarboxylic acids or their salts in which the polycarboxylic acid comprises at least two carboxylic radicals separated from each other by not more that two carbon atoms, and mixtures of any of the foregoing.

Preferred builder compounds include citrate, tartrate, succinates, oxydissuccinates, carboxymethyloxysuccinate, nitrilotriacetate, and mixtures thereof.

Highly preferred maybe that one or more fatty acids and/or optionally salts thereof (and then preferably sodium salts) are present in the detergent composition. It has been found that this can provide further improved softening and cleaning of the fabrics. Preferably, the compositions comprise from about 2% to about 40%, more preferably from about 5% to about 30%, and most preferably about 10% to about 25% by weight of the composition of a fatty acid or salt thereof Preferred are in particular C₁₂-C₁₈ saturated and/or unsaturated, linear and/or branched, fatty acids, but preferably mixtures of such fatty acids. Highly preferred have been found mixtures of saturated and unsaturated fatty acids, for example preferred is a mixture of rape seed-derived fatty acid and C16-C18 topped whole cut fatty acids, or a mixture of rape seed-derived fatty acid and a tallow alcohol derived fatty acid, palmitic, oleic, fatty alkylsuccinic acids, and mixtures thereof.

The compositions of the invention may comprise phosphate-containing builder material. Preferably present at levels of from about 2% to about 40%, more preferably from about 5% to about 30%, more preferably from about 10% to about 25%. Suitable examples of water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerization ranges from about 6 to about 21, and salts of phytic acid.

The compositions in accord with the present invention may contain a partially soluble or insoluble builder compound, typically present in detergent compositions at levels of from about 0.5% to about 60% by weight, preferably from about 5% to about 50% by weight, most preferably from about 8% to about 40% weight of the composition.

Preferred are aluminosilicates and, or crystalline layered silicates such as SKS-6, available from Clariant.

However, from a formulation point of view it may be preferred not to include such builders in the liquid composition, because it will lead to too much dispersion or precipitation.

Radical Scavengers

The laundry additives of the present invention may comprise a radical scavenger or a mixture thereof. Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl)butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®.

Radical scavengers when used, are typically present herein in amounts up to about 10% by weight of the total laundry additive and preferably from about 0.001% to about 0.5% by weight.

Suds Controlling Agents

The laundry additives according to the present invention may further comprise a suds controlling agent such as 2-alkyl alkanol, or mixtures thereof, as a preferred optional ingredient. Particularly suitable to be used in the present invention are the 2-alkyl alkanols having an alkyl chain comprising from about 6 to about 16 carbon atoms, preferably from about 8 to about 12 and a terminal hydroxy group, said alkyl chain being substituted in the a position by an alkyl chain comprising from 1 to about 10 carbon atoms, preferably from about 2 to about 8 and more preferably about 3 to about 6. Such suitable compounds are commercially available, for instance, in the Isofol® series such as Isofol® 12 (2-butyl octanol) or Isofol® 16 (2-hexyl decanol).

Other suds controlling agents may include alkali metal (e.g., sodium or potassium) fatty acids, or soaps thereof, containing from about 8 to about 24, preferably from about 10 to about 20 carbon atoms.

The fatty acids including those used in making the soaps can be obtained from natural sources such as, for instance, plant or animal-derived glycerides (e.g., palm oil, coconut oil, babassu oil, soybean oil, castor oil, tallow, whale oil, fish oil, tallow, grease, lard and mixtures thereof). The fatty acids can also be synthetically prepared (e.g., by oxidation of petroleum stocks or by the Fischer-Tropsch process).

Alkali metal soaps can be made by direct saponification of fats and oils or by the neutralization of the free fatty acids which are prepared in a separate manufacturing process. Particularly useful are the sodium and potassium salts of the mixtures of fatty acids derived from coconut oil and tallow, i.e., sodium and potassium tallow and coconut soaps.

The term “tallow” is used herein in connection with fatty acid mixtures which typically have an approximate carbon chain length distribution of 2.5% C14, 29% C16, 23% C18, 2% palmitoleic, 41.5% oleic and 3% linoleic (the first three fatty acids listed are saturated). Other mixtures with similar distribution, such as the fatty acids derived from various animal tallows and lard, are also included within the term tallow. The tallow can also be hardened (i.e., hydrogenated) to convert part or all of the unsaturated fatty acid moieties to saturated fatty acid moieties.

When the term “coconut” is used herein it refers to fatty acid mixtures which typically have an approximate carbon chain length distribution of about 8% C8, 7% Cd10, 48% C12, 17% C14, 9% C16, 2% C18, 7% oleic, and 2% linoleic (the first six fatty acids listed being saturated). Other sources having similar carbon chain length distribution such as palm kernel oil and babassu oil are included with the term coconut oil.

Other suitable suds controlling agents are exemplified by silicones, and silica-silicone mixtures. Silicones can be generally represented by alkylated polysiloxane materials while silica is normally used in finely divided forms exemplified by silica aerogels and xerogels and hydrophobic silicas of various types. These materials can be incorporated as particulates in which the suds controlling agent is advantageously releasable incorporated in a water-soluble or water-dispersible, substantially non-surface-active detergent impermeable carrier. Alternatively the suds controlling agent can be dissolved or dispersed in a liquid carrier and applied by spraying on to one or more of the other components.

A preferred silicone suds controlling agent is disclosed in Bartollota et al. U.S. Pat. No. 3,933,672. Other particularly useful suds controlling agents are the self-emulsifying silicone suds controlling agents, described in German Patent Application DTOS 2 646 126 published Apr. 28, 1977. An example of such a compound is DC-544, commercially available from Dow Coming, which is a siloxane-glycol copolymer.

Especially preferred silicone suds controlling agents are described in Copending European Patent application N^{o} 92201649.8. Said laundry additives can comprise a silicone/silica mixture in combination with fumed nonporous silica such as Aerosil®.

A preferred type of suds controlling agent is an alkyl capped alcohol alkoxylate. The alkyl chain of the alcohol can be fromC₃-C₃₀, the alkoxylate is preferably ethoxylate comprising preferably from about 1 to about 30 moles thereof and the cap is preferably a C₁-C₆ linear or branched alkyl group.

Especially preferred suds controlling agent are the suds controlling agent system comprising a mixture of silicone oils and the 2-alkyl-alcanols.

Typically, the laundry additives herein may comprise up to about 4% by weight of the total laundry additive of a suds controlling agent, or mixtures thereof, preferably from about 0.1% to about 1.5% and most preferably from about 0.1% to about 0.8%.

Stabilisers

The laundry additives of the present invention may further comprise a stabiliser. Where present the stabiliser is present at a level of up to about 10%, preferably from about 2% to about 4% by weight of the total laundry additive of an alcohol according to the formula HO—CR′R″—OH, wherein R′ and R″ are independently H or a C₂-C₁₀ hydrocarbon chain and/or cycle. Preferred alcohol according to that formula is propanediol. Indeed, we have observed that these alcohols in general and propanediol in particular also improve the chemical stability of the laundry additives.

Other stabilizers like inorganic stabilizers may be used herein. Examples of inorganic stabilizers include sodium stannate and various alkali metal phosphates such as the well-known sodium tripolyphosphates, sodium pyrophosphate and sodium orthophosphate.

Suds Booster

If high sudsing is desired, suds boosters such as C₁₀-C₁₆ alkanolamides can be incorporated into the laundry additives, typically at about 1%-10% levels. The C₁₀-C₁₄ monoethanol and diethanol amides illustrate a typical class of such suds boosters. Use of such suds boosters with high sudsing adjunct surfactants such as the amine oxides, betaines and sultaines noted above is also advantageous. If desired, soluble magnesium salts such as MgCl₂, MgSO₄, and the like, can be added at levels of, for example, about 0.1%-2%, to provide additional suds and to enhance grease removal performance.

Suds Suppressing System

The composition may comprise a suds suppresser at a level less than about 10%, preferably about 0.001% to about 10%, preferably from about 0.01% to about 8%, most preferably from about 0.05% to about 5%, by weight of the composition Preferably the suds suppresser is either a soap, paraffin, wax, or any combination thereof. If the suds suppresser is a suds suppressing silicone, then the detergent composition preferably comprises from about 0.005% to about 0.5% by weight a suds suppressing silicone. Suitable suds suppressing systems for use herein may comprise essentially any known antifoam compound, including for example silicone antifoam compounds and 2-alkyl alcanol antifoam compounds.

Other suitable antifoam compounds include the monocarboxylic fatty acids and soluble salts thereof, as also described as builders above. These materials are described in U.S. Pat. No. 2,954,347, issued Sep. 27, 1960 to Wayne St. John. The monocarboxylic fatty acids, and salts thereof, for use as suds suppressor typically have hydrocarbyl chains of about 10 to about 24 carbon atoms, preferably about 12 to about 18 carbon atoms. Suitable salts include the alkali metal salts such as in particular sodium but also potassium salts.

### Organic Polymeric Compounds

Useful additional non-alkoxylated organic polymeric compounds for inclusion in the compositions herein include the water soluble organic homo-or copolymeric polycarboxylic acids or their salts in which the polycarboxylic acid comprises at least two carboxyl radicals separated from each other by not more than two carbon atoms. Polymers of the latter type are disclosed in GB-A-1,596,756. Examples of such salts are polyacrylates of MWt 1000-5000 and their copolymers with maleic anhydride, such copolymers having a molecular weight of from about 2000 to about 100,000, especially from about 40,000 to about 80,000.

Other organic polymeric compounds suitable for incorporation in the detergent compositions herein include cellulose derivatives.

Dye-Transfer Inhibitors

The compositions herein may also comprise from about 0.01% to about 10%, preferably from about 0.05% to about 0.5% by weight of polymeric dye transfer inhibiting agents. The polymeric dye transfer inhibiting agents are preferably selected from polyamine N-oxide polymers, copolymers of N-vinylpyrrolidone and N-vinylimidazole, polyvinylpyrrolidonepolymers or combinations thereof, whereby these polymers can be cross-linked polymers.

Alkoxylated Amine, Imine, Amide, Imide Compound

The composition can comprise one or more alkoxylated compounds having at least two alkoxylated amine, imine, amide or imide groups.

Preferred are compounds having at least two alkoxylated amine groups.

The alkoxylation group may have one or more alkoxylates, typically more than one, thus forming a chain of alkoxylates, or polyalkoxylation group.

The compound may have two alkoxylation groups or chain, preferably at least about 4 or even at least about 7 or even at least about 10 or even at least about 16. Preferred is that the alkoxylation groups are polyalkoxylation groups, (each independently) having an average alkoxylation degree of at least about 5, more preferably at least about 8, preferably at least about 12, up to preferably about 80 or even to about 50 or even to about 25.

The (poly)alkoxylation is preferably a (poly)ethoxylation and/or (poly)propoxylation. Thus, preferred is that the alkoxylation group is a polyethoxylation group or polypropoxylation group, or a (poly)ethoxylation/(poly)propoxyltion group.

Preferred may be that these compounds are polymers having such groups. When used herein an polymer is a compound having 2 or more repeating monomer units forming a backbone. The alkoxylated polymer herein is preferably such that the alkoxylation groups are not part of the backbone of the polymer, but are alkoxylation groups of the amine, imine, amide or imide in the units forming the backbone, or are alkoxylation groups of other side-groups chemically bound to the backbone.

Said alkoxylated compound is preferably a polyamide, polyimide or more preferably a polyamine or polyime compound, whereby these amide, imide, amine or imine units are present as backbone of the polymer, forming the chain of repeating units. Preferably, these polymers have at least about 3 or about even about 4 or even about 5 amide, imide, amine or imine units. Hereby, it may be preferred that only some of the amine or imine are alkoxylated.

It may be preferred that the backbone has also side-chains containing amide, imide, amine or imine groups, which may be alkoxylated.

Preferred are compounds having a weight average molecular weight of about 200 to about 50,000, preferably to about 20,000 or even to about 10,000, or even from about 350 to about 5000 or even to about 2000 or even to about 1000.

Preferably the composition herein (described in more detail hereinafter) comprises (by weight of the composition) from about 0.5% to about 15%, more preferably from about 0.8% to about 10%, more preferably from about 1.5% to about 8%, more preferably from about 2.0% or even about 2.5% or even about 3% to about 6% of said alkoxylated compound. The composition herein may comprise preferably mixtures of the specified compounds.

Highly preferred are ethoxylated poly(ethyleneimine), preferably having an average ethoxylationd degree per ethoxylation chain of about 15 to about 25, and a molecular weight of about 1000-2000 dalton. Also highly preferred are ethoxylated tetraethylene pentaimines.

Soil Suspending Agents

The composition of the present invention may preferably comprise a suspending agent. A suspending agent is an ingredient that is specifically added to the composition of the present invention to suspend a solid particulate ingredient of the composition.

Suitable suspending agents are those known in the art. Examples of suspending agents include gum-type polymers, polyvinyl alcohol and derivatives thereof, cellulose and derivatives thereof and polycarboxylate polymers including, but not limited to: tamarind gum, guar gum, locust bean gum, and other industrial gums and polymers, which include, but are not limited to, gellan, welan, rhamsan, dextran, curdlan, hydroxyalkyl cellulose, galactan, pectic galactan, galactomannan, glucomannan, lichenan, mannan, acacia gum, agar, alginates, carrageenan, chitosan, clavan, hyaluronic acid, cellodextrins, carboxymethylcellulose (CMC), dextrans, dextrins, ethylhydroxyethylcellulose (EHEC), guar, hydroxyethylcellulose (HEC), hydroxypropylcellulose (HPC), hydroxybutylcellulose (HBC), methylcellulose (MC), tamarind, xanthan, carboxymethylhydroxyethylcellulose (CMHEC), methoxypropyl methyl cellulose (MPMC), hexylcarboxymethyl cellulose, C₁₂-C₂₀ alkyl carboxymethylcellulose, methylhydroxyethylcellulose (MHEC), methylhydroxypropylcellulose (MHPC), hydroxyethylmethylcellulose (HEMC), hydroxypropylmethylcellulose (HPMC), hydroxybutylmethylcellulose (HBMC) and mixtures thereof.

In a particularly preferred embodiment of the present invention, the suspending agent is selected from a gum-type polymer, preferably a xanthan gum, or a polycarboxylate polymer, preferably a homo or copolymer of monomer units selected from acrylic acid, methacrylic acid, maleic acid, malic acid, maleic anhydride, preferably in a MW range from about 1,000,000 to about 10,000,000.

The gum-type polymer, when present, is preferably present at a level of from about 0.01% to about 10%, most preferably from about 0.1% to about 3%.

The cross-linked polycarboxylate polymer, when present, is preferably present at a level of from about 0.01% to about 2% more preferably from about 0.01% to about 1%, most preferably from about 0.1% to about 0.8%.

In an alternative embodiment the suspending agent comprises a combination of at least two polymers. In this embodiment the first polymer is a gum-type polymer and the second is a cross-linked polycarboxylate polymer. The composition may additionally comprise further polymers. The ratio of gum-type polymer to cross-linked polycarboxylate polymer is from about 100:1 to about 1:100, most preferably from about 1:10 to about 10:1.

Preferably, the soil suspending agent is an ethoxylated cationic diamine, more preferably the soil suspending agent is a 24-Ethoxylated Hexamethylene Diamine Quaternized.

Optical Brightener

The laundry composition may optionally comprise an optical brightener. Where present the brightener is present at a level of from about 0.005% to about 5%, more preferably from about 0.01% to about 1%, most preferably from about 0.01% to about 0.5%.

The optical brighteners suitable for use in the present invention are substantially insoluble in water. Wherein substantially insoluble means that less than 1 gram of the brightener will dissolve in 1 liter of distilled water at pH 7. Nonionic brighteners, meaning those brighteners that do not have any permanently charged group or a group selected from sulphonic, sulphate, carboxylic, phosphonate, phosphate and quaternary ammonium.

In a preferred embodiment, the optical brightener is a substantially insoluble compound selected from compounds comprising stilbene, pyrazoline, coumarin, carboxylic acids, methinecyanines, dibenzothiophene-5,5-dioxide, azoles, 5- and 6-membered-ring heterocyclic, benzene or derivatives thereof and mixtures thereof. More preferably the brightener comprises a benzoxozol, pyrazole, triazole, triazine, imidazole, furan group or mixtures thereof.

Examples of preferred commercially available optical brighteners include those selected from the group consisting of Benzoxazole, 2,2′-(2,5-thiophenediyl)bis-(7CI, 8CI, 9CI) sold under the tradename Tinopal SOP (from Ciba-Geigy, C.I. Fluorescent Brightener 140 (9CI), 7-(dimethylamino)-4-methyl-2H-1-benzopyran-2-one (9CI) sold under the tradename Tinopal SWN (from Ciba-Geigy), Benzoxazole, 2,2′-(1,2-ethenediyl)bis[5-methyl-(9CI) sold under the tradename Tinopal K (from Ciba-Geigy), C.I. Fluorescent Brightener 352 (9CI) 1H-Benzimidazole, 2,2′-(2,5-furandiyl)bis[1-methyl-(9CI) sold under the tradename Uvitex AT (from Ciba-Geigy).

Perfume

Highly preferred are perfume components, preferably at least one component comprising a coating agent and/or carrier material, preferably organic polymer carrying the perfume or aluminosilicate carrying the perfume, or an encapsulate enclosing the perfume, for example starch or other cellulosic material encapsulate. The inventors have found that the perfumes are more efficiently deposited onto the fabric in the compositions of the invention.

Preferably the pouch compositions of the present invention comprise from 0.01 about to about 4% of perfume, more preferably from about 0.1% to about 2%.

Enzymes

Another preferred ingredient useful in the compositions herein is one or more enzymes.

Suitable enzymes include enzymes selected from peroxidases, proteases, gluco-amylases, amylases, xylanases, cellulases, lipases, phospholipases, esterases, cutinases, pectinases, keratanases, reductases, oxidases, phenoloxidases, lipoxygenases, ligninases, pullulanases, tannases, pentosanases, malanases, β-glucanases, arabinosidases, hyaluronidase, chondroitinase, dextranase, transferase, laccase, mannanase, xyloglucanases, or mixtures thereof. Detergent compositions generally comprise a cocktail of conventional applicable enzymes like protease, amylase, cellulase, lipase. Enzymes are generally incorporated in detergent compositions at a level of from about 0.0001% to about 2%, preferably from about 0.001% to about 0.2%, more preferably from about 0.005% to about 0.1% pure enzyme by weight of the composition. The above-mentioned enzymes may be of any suitable origin, such as vegetable, animal, bacterial, fungal and yeast origin. Origin can further be mesophilic or extremophilic (psychrophilic, psychrotrophic, thermnophilic, barophilic, alkalophilic, acidophilic, halophilic, etc.). Purified or non-purified forms of these enzymes may be used. Nowadays, it is common practice to modify wild-type enzymes via protein/genetic engineering techniques in order to optimize their performance efficiency in the detergent compositions of the invention. For example, the variants may be designed such that the compatibility of the enzyme to commonly encountered ingredients of such compositions is increased. Alternatively, the variant may be designed such that the optimal pH, bleach or chelant stability, catalytic activity and the like, of the enzyme variant is tailored to suit the particular cleaning application. In regard of enzyme stability in liquid detergents, attention should be focused on amino acids sensitive to oxidation in the case of bleach stability and on surface charges for the surfactant compatibility. The isoelectric point of such enzymes may be modified by the substitution of some charged amino acids. The stability of the enzymes may be further enhanced by the creation of e.g. additional salt bridges and enforcing metal binding sites to increase chelant stability. Furthermore, enzymes might be chemically or enzymatically modified, e.g. PEG-ylation, cross-linking and/or can be immobilized, i.e. enzymes attached to a carrier can be applied. The enzyme to be incorporated in a detergent composition can be in any suitable form, e.g. liquid, encapsulate, prill, granulate . . . or any other form according to the current state of the art.

Method of Treating Laundry

The present invention also relates to a method of treating laundry using a pouch. An essential feature of the present invention is that the pouch is delivered into the washing machine by directly charging the drum of the washing machine with the pouch. The pouch is charged into the drum in view of being in a direct contact with the fabric to be treated and not in the dispenser drawer of the washing machine.

Indeed, an advantage of the method of treatment according to the present invention is that, when charging the pouch into the drum of the washing machine, the patchy damage are considerably reduced and even disappear, whereas when using the pouch in the dispenser of the washing machine, it create patchy damage.

As used herein, “the drum” refers to a washing basin/machine drum or to any system which allow the composition to be direct contact with the fabric prior the washing process of the washing machine. The use of the pouch into the drum is opposed to the use of the composition though a dispenser.

As used herein, “dispenser” refers to any system of withdrawing, removing, or channelling the composition of the present invention which introduce the compositions into the laundry process without being in contact with the fabric.

The method of treating laundry necessarily involves a washing step. The washing step according to the present invention is performed in a washing machine.

Fabrics to be treated herein include, but are not limited to, clothes, curtains, drapes, bed linens, bath linens, tablecloths, sleeping bags and/or tents. By “treating a fabric”, it is meant herein cleaning said fabric.

The process of washing fabrics according to the present invention may comprise the steps of diluting, dissolving or dispersing the composition in a bath of wash water.

By “diluted, dissolved or dispersed” it is meant herein, that at least about 50%, preferably at least about 80%, more preferably at least about 90%, even more preferably at least about 95%, still more preferably at least about 98%, and most preferably at least about 99%, of said conventional laundry detergent are diluted, dissolved or dispersed in the aqueous bath fonned in the process according to the present invention.

The term “bath” as used herein to define any suitable receptacle for the water. Such a receptacle may for example be a bath tub or a bucket. Alternatively, the receptacle may be a washing machine.

According to the process of the present invention, a conventional detergent composition can be charged to the washing machine by way of the dispenser drawer of the washing machine or by directly charging the drum of the washing machine. The pouch is loaded directly into the drum of the washing machine. Preferably the conventional laundry detergent and the sachet are both directly placed into the drum of the washing machine.

By “conventional laundry detergent” it is meant herein, a laundry detergent composition currently available on the market. Preferably, said conventional laundry detergent comprises at least one surfactant. Said laundry detergent compositions may be formulated as powders, liquids or tablets. Suitable laundry detergent compositions are for example DASH futur®, DASH liquid®, ARIEL tablets® and other products sold under the trade names ARIEL® or TIDE®.

### EXAMPLE I

A piece of plastic is placed in a mould to act as a false bottom. The mould consists of a cylindrical shape and has a diameter of 45 mm and a depth of 25 mm. A 1 mm thick layer of rubber is present around the edges of the mould. The mould has some holes in the mould material to allow a vacuum to be applied. With the false bottom in place the depth of the mould is 12 mm. A piece of Chris-Craft M-8630 film is placed on top of this mould and fixed in place. A vacuum is applied to pull the film into the mould and pull the film flush with the inner surface of the mould and the false bottom. 5 mL of the liquid component of a detergent composition is poured into the mould. Next, a second piece of Chris-Craft M-8630 film is placed over the top of the mould with the liquid component and sealed to the first piece of film by applying an annular piece of flat metal of an inner diameter of 46 mm and heating that metal under moderate pressure onto the ring of rubber at the edge of the mould to heat-seal the two pieces of film together to form a compartment comprising the liquid component. The metal ring is typically heated to a temperature of from 135° C. to 150° C. and applied for up to 5 seconds.

The compartment comprising the liquid compartment is removed from the mould and the piece of plastic acting as a false bottom is also removed from the mould. A third piece of Chris-Craft M-8630 film is placed on top of the mould and fixed in place. A vacuum is applied to pull the film into the mould and pull the film flush with the inner surface of the mould. 40 g of the solid component of the detergent composition is poured into the mould. Next, the compartment comprising the liquid component is placed over the top of the mould with the solid component and is sealed to the third layer of film by applying an annular piece of flat metal of an inner diameter of 46 mm and heating that metal under moderate pressure onto the ring of rubber at the edge of the mould to heat-seal the pieces of film together to form a pouch comprising two compartments, where a first compartment comprises the liquid component of the detergent composition and a second compartment comprises the solid component of the detergent composition. The metal ring is typically heated to a temperature of from 135° C. to 150° C. and applied for up to 5 seconds.

### EXAMPLE II

A pouch was made by the process described in example I which comprises the following liquid component and solid component.

| | Amount (by weight | | |
|---|---|---|---|
| Solid component | of solid component) | | |
| Polymer I | 20.00 | 5.00 | 18.00 |
| Sodium Percarbonate | 74.90 | 74.90 | 76.90 |
| Tinopal CBS | 0.50 | 0.40 | 0.60 |
| HEDP | 1.50 | 1.50 | 1.40 |
| FN4 | 0.90 | 0.90 | 1.00 |
| Termamyl 150 | 0.50 | 0.50 | 0.40 |
| Natalase 90 CT | 1.60 | 1.70 | 1.60 |
| Perfume | 0.10 | 0.10 | 0.10 |
| | Amount (by weight | | |
| Liquid component | of liquid component) | | |
| Cycloexane | 20.00 | — | — |
| EtOH | — | — | 30.00 |
| Glycerin | 10.00 | 1.98 | 12.00 |
| Triacetine | 60.00 | 70.00 | 85.00 |
| DPG | 15.00 | 20.00 | 10.00 |
| Water | Up to 100 | Up to 100 | Up to 100 |

### ABBREVIATIONS USED IN EXAMPLES

In the examples, the abbreviated component identifications have the following meanings:

| | |
|---|---|
| Polymer I | Acrylic Acid/Maleic Acid copolymer |
| HEDP (Chelating agent) | Ethane 1-hydroxy-1,1-diphosphonic acid- |
| Percarbonate (Bleach) | Sodium percarbonate (2Na₂CO₃•3H₂O₂) |
| Termamyl | α-amylase available from Novo Nordisk A/S |
| Natalase | α-amylase available from Novo Nordisk A/S |
| FN4 | protease available from Genencor |
| DPG (Solvent) | dipropylene glycol |
| Tinopal CBS (Brightener) | Available from Ciba-Geigy |

The pouch is introduced in the DRUM compartment of a Bosch Siemens 6032 dishwashing machine, the dispenser is closed and the washing machine operated in its normal 55° C. program.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is

1. A laundry multi-compartment pouch made from a water-soluble film and having at least two compartments, said multi-compartment pouch comprises a composition comprising a solid component and a liquid component, wherein;
(a) a first compartment comprises a liquid component, said liquid compartment containing a bleach activator,
(b) a second compartment comprises a solid component, said solid compartment containing from 60 to 95% of a peroxide source.

2. A multi-compartment pouch according to claim 1 wherein the solid component composition comprises a peroxide source in an amount of from 65 to 85%, more preferably of from 70 to 80% by weight of the solid component of the composition.

3. A multi-compartment pouch according to any of the preceding claims wherein the solid component comprises sodium percarbonate as peroxide source

4. A multi-compartment pouch according to any of the preceding claims wherein the bleach activator is selected from the group constituted of nonanoyloxybenzenesulphonate, n-nonanoylsuccinimid, N-acyl caprolactams, tetracetyl ethylene diamine, acetyl triethyl citrate, triacetin and mixtures thereof.

5. A multi-compartment pouch claim 4 wherein the bleach activator is triacetin.

6. A multi-compartment pouch according to any of the preceding claims wherein the water-soluble film material is selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, polyvinyl alcohol copolymers and hydroxypropyl methyl cellulose and mixtures thereof.

7. A multi-compartment pouch according to claim 6 wherein the water-soluble film of the pouch comprises a polyvinyl alcohol polymer.

8. A multi-compartment pouch according to any of the preceding claims wherein the pouch is a dual-compartment pouch.

9. A multi-compartment pouch according to any of the preceding claims wherein the composition further comprises ingredient selected form the group constituting of surfactant, building agent, chelating agents, dye, polymers, brighteners, enzymes, suds boosters, suds suppressors, perfumes and mixtures thereof.

10. A multi-compartment pouch according to any of the preceding claims wherein the liquid component of the pouch comprises a surfactant, whereby said surfactant is a nonionic surfactant, an anionic surfactant or a combination thereof, preferably a nonionic surfactant.

11. A method of treating fabrics by placing the pouch, according to any of the claims 1 to 10, in the drum of the washing machine.

12. The use of the multi-compartment pouch according to any of the claims 1 to 10 in view of reducing the patchy damage when treating fabrics.
